(19) United States
(12) Patent Application Publication
(10) Pub. No.: US 2024/0355348 A1
(43) Pub. Date: Oct. 24, 2024

(54) DETECTING ENVIRONMENTAL NOISE IN USER-GENERATED CONTENT

(71) Applicant: DOLBY LABORATORIES LICENSING CORPORATION, San Francisco, CA (US)

(72) Inventors: Ziyu Yang, Beijing (CN); Zhiwei Shuang, Beijing (CN); Lie Lu, Dublin, CA (US)

(73) Assignee: DOLBY LABORATORIES LICENSING CORPORATION, San Francisco, CA (US)

(21) Appl. No.: 18/685,656

(22) PCT Filed: Aug. 23, 2022
(86) PCT No.: PCT/US22/41130

§ 371 Date: Feb. 22, 2024

Related U.S. Application Data
(60) Provisional application No. 63/244,495, filed on Sep. 15, 2021.

(30) Foreign Application Priority Data
Aug. 26, 2021 (WO) PCT/CN2021/114746
Nov. 3, 2021 (EP) 21206205.3

(51) Int. Cl. G10L 21/0216; G10L 21/0264

(52) U.S. Cl. CPC G10L 21/0216; G10L 21/0264

(57) ABSTRACT

A method of audio processing includes classifying an audio signal as noise or as non-noise using a first model. For a noise signal. the audio signal is classified as user-generated content (UGC) noise or as professionally-generated content (PGC) noise using a second model. For a non-noise signal or PGC noise. the audio signal is processed using a first audio processing process. For UGC noise. the audio signal is processed using a second audio processing process.

### CROSS REFERENCE TO RELATED APPLICATIONS

This application claims the benefit of priority from PCT International application No. PCT/CN2021/114746, filed Aug. 26, 2021, U.S. Provisional Application No. 63/244,495, filed Sep. 15, 2021, and European Patent application No. 21206205.3, filed Nov. 3, 2021, each of which are hereby incorporated by reference in its entirety.

### FIELD

The present disclosure relates to audio processing, and in particular, to noise reduction.

### BACKGROUND

Unless otherwise indicated herein, the approaches described in this section are not prior art to the claims in this application and are not admitted to be prior art by inclusion in this section.

Multimedia content, including audio, video, and combined audio/video, has always been important in the field of entertainment. Among the content, professionally generated content (PGC) represented by movies and television shows used to be the dominant form of multimedia content. In recent years, however, the user generated content (UGC) has become drastically increasing. This is benefited from the rapid development of capturing devices, network platforms, and playback side techniques. For the aspect of capturing devices, portable devices represented by smart phones and tablets has become common. The user can capture and create UGC individually with the equipped camera and microphone. In addition, various platforms like general video websites and arising mobile applications vastly accelerate the propagating of UGC.

Numerous techniques have been developed for content playback for the purpose of enhancing visual and auditory experiences. Audio processing techniques, such as Dolby™ Audio Processing, may be applied during playback to improve the audio quality. Audio processing systems have been mainly focused on PGC; however, the increasing popularity of UGC provides an opportunity to apply audio processing also to UGC.

### SUMMARY

One issue with existing audio processing systems is that the techniques used for PGC may differ from the techniques used for UGC. In contrast to the PGC with high audio quality, a lot of UGC has low audio quality. It can be attributed to the non-professional recording devices, complex environments and less editing procedures. The quality issues include but are not limited to the poor speech intelligibility, strong reverberation, etc. One of the most common issues is environmental noise contained in UGC, hereafter called the UGC noise. The UGC noise can be easily captured by using the mobile phone in real scenes. In general, the UGC noise is the background noise and thus meaningless or unwanted. Therefore, the UGC noise should be prevented to be boosted by any of the volume adjusting techniques, especially for the approximately stationary noise. This is because boosting this kind of noise would be obviously perceived by listeners, negatively impacting the user experience. On the other hand, if the audio processing system knows that there exists UGC noise in the content, proper noise reduction methods can be applied to the UGC noise for improving the audio quality.

However, the PGC also contains approximately stationary noise-like content, hereafter called the PGC noise. The PGC noise may commonly include noise intervals, such as the background sound intervals between adjacent dialogue intervals in a movie. This PGC noise is usually captured independently from the dialogue using professional recording devices, and is carefully processed by the audio mixer in the content creation phase. In contrast to the UGC noise, the PGC noise is part of the content and is usually wanted from perspective of the artists and content creators. In such cases, no noise reduction method should be applied, while the techniques like volume leveling can safely boost the PGC noise.

Consequently, the UGC noise and the PGC noise should be handled differently. A method to detect the UGC stationary noise while distinguishing from the PGC noise is highly desired. Such a method can be further used for steering the post-processing techniques for audio content playback. Embodiments are directed to a two-stage noise classification system.

According to an embodiment, a computer-implemented method of audio processing includes receiving an audio signal and calculating a first confidence score of the audio signal using a first machine learning model. The method further includes, when the first confidence score indicates a presence of non-noise, generating a processed audio signal by processing the audio signal according to a first audio processing process. The method further includes, when the first confidence score indicates a presence of noise, calculating a second confidence score of the audio signal using a second machine learning model. The method further includes, when the second confidence score indicates a presence of user-generated content (UGC) noise, generating the processed audio signal by processing the audio signal according to a second audio processing process. The method further includes, when the second confidence score indicates a presence of professionally-generated content (PGC) noise, generating the processed audio signal by processing the audio signal according to the first audio processing process.

Calculating the first confidence score may include extracting a first plurality of features from the audio signal; classifying the first plurality of features using the first machine learning model; calculating a noise confidence score based on a result of classifying the first plurality of features; and calculating a weight based on the noise confidence score.

Calculating the second confidence score may include extracting a second plurality of features from the audio signal, wherein the second plurality of features is extracted over a longer time period than the first plurality of features is extracted; calculating a second plurality of statistics based on the second plurality of features, wherein the second plurality of statistics is weighted according to the weight; classifying the second plurality of features and the second plurality of statistics using the second machine learning model; and calculating the second confidence score based on a result of classifying the second plurality of features and the second plurality of statistics.

According to another embodiment, an apparatus includes a loudspeaker and a processor. The processor is configured to control the apparatus to implement one or more of the methods described herein. The apparatus may additionally include similar details to those of one or more of the methods described herein.

According to another embodiment, a non-transitory computer readable medium stores a computer program that, when executed by a processor, controls an apparatus to execute processing including one or more of the methods described herein.

The following detailed description and accompanying drawings provide a further understanding of the nature and advantages of various implementations.

### BRIEF DESCRIPTION OF THE DRAWINGS

FIG. 1 is a block diagram of a noise classification system 100.

FIG. 2 is a block diagram showing details of the noise detector 102 (see FIG. 1).

FIG. 3 is a block diagram showing details of the noise discriminator 104 (see FIG. 1).

FIG. 4 is a mobile device architecture 400 for implementing the features and processes described herein, according to an embodiment.

FIG. 5 is a flowchart of a method 500 of audio processing.

### DETAILED DESCRIPTION

Described herein are techniques related to audio processing. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

In the following description, various methods, processes and procedures are

detailed. Although particular steps may be described in a certain order, such order is mainly for convenience and clarity. A particular step may be repeated more than once, may occur before or after other steps, even if those steps are otherwise described in another order, and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive-or is intended, such will be specifically noted, e.g., “either A or B”, “at most one of A and B”.

This document describes various processing functions that are associated with structures such as blocks, elements, components, circuits, etc. In general, these structures may be implemented by a processor that is controlled by one or more computer programs.

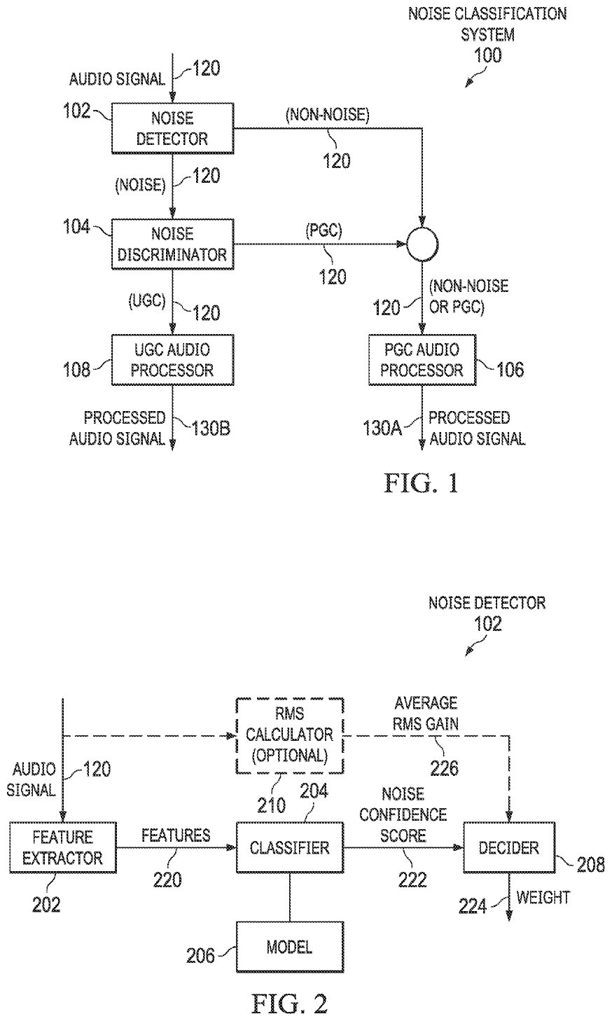

FIG. 1 is a block diagram of a noise classification system 100. In general, the noise classification system 100 receives an audio signal, performs noise classification, and generates a processed audio signal in accordance with the noise classification. The components of the noise classification system 100 may be implemented as one or more computer programs that are executed by a processor. The noise classification system 100 includes a noise detector 102, a noise discriminator 104, a PGC audio processor 106, and a UGC processor 108.

The noise detector 102 receives an audio signal 120 and performs noise detection. When the noise detection indicates that the audio signal 120 includes noise, e.g. UGC noise, PGC noise, etc., the noise detector 102 provides the audio signal 120 to the noise discriminator 104 for further processing. When the noise detection indicates that the audio signal 120 includes non-noise, e.g. music, speech, etc., the noise detector 102 provides the audio signal 120 to the PGC audio processor 106 for further processing. Further details of the noise detector 102 are provided with reference to FIG. 2.

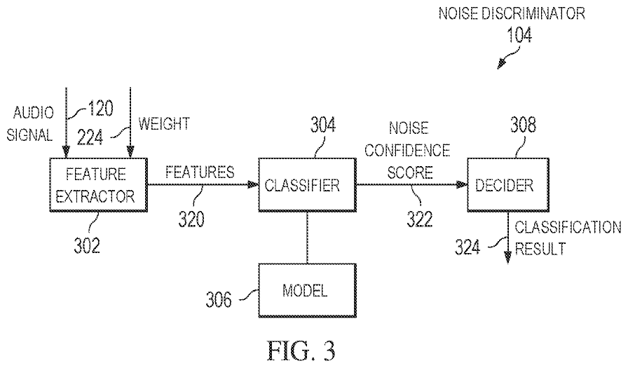

The noise discriminator 104 receives the audio signal 120, e.g. from the noise detector 102, and performs noise discrimination. Recall that the audio signal 120 provided to the noise discriminator 104 has been previously classified as “noise” by the noise detector 102. When the noise discrimination 104 indicates that the audio signal 120 includes PGC noise, the noise discriminator 104 provides the audio signal 120 to the PGC audio processor 106 for further processing. When the noise discrimination indicates that the audio signal 120 includes UGC noise, the noise discriminator 104 provides the audio signal 120 to the UGC audio processor 108 for further processing. Further details of the noise discriminator 104 are provided in FIG. 3.

The PGC audio processor 106 receives the audio signal 120 from the noise detector 102, indicating non-noise, or from the noise discriminator 104, indicating PGC noise, performs audio processing according to a first audio processing process, and generates a processed audio signal 130a. The first audio processing process generally corresponds to audio processing settings that are appropriate to use for non-noise audio, such as dialogue enhancement, volume leveling, etc. For example, when the listener desires their mobile telephone, e.g. that implements the noise classification system 100, to perform volume leveling when outputting the processed audio signal, using the first audio processing settings results in output audio with the volume leveling applied. The first audio processing settings are also appropriate to use when PGC noise is detected, because they will likely conform the listener's experience to the intended audio experience of the content creator. For example, it would be appropriate to apply volume leveling to PGC when volume leveling is desired by the listener.

The UGC audio processor 108 receives the audio signal 120 from the noise discriminator 104, indicating UGC noise, performs audio processing according to a second audio processing process, and generates a processed audio signal 130b. The second audio processing process generally corresponds to audio processing settings that are appropriate to use for UGC noise, e.g., stationary noise. For example, when the listener desires their mobile telephone, e.g. that implements the noise classification system 100, to perform noise reduction when outputting the processed audio signal, using the second audio processing settings results in output audio with the noise reduction applied. Because UGC often has stationary noise, performing noise reduction on this content results in an improved listener experience.

Consider the following example. Assume that the user wants both volume leveling and noise reduction to be applied to the audio output, and that the content contains traffic noise, e.g., a type of stationary noise. When the listener is watching a Hollywood movie on their mobile telephone, performing volume leveling is appropriate and performing noise reduction is not appropriate, because not overly reducing the traffic noise is appropriate to preserve the content creator's artistic intent. In this situation, the noise classification system 100 detects the PGC noise, applies the first audio processing settings, and outputs the audio output appropriately. When the listener is watching a video that they captured while walking on the sidewalk outside, performing both volume leveling and noise reduction are appropriate, because reducing the traffic noise provides an improved listener experience, as opposed to boosting the traffic noise when performing volume leveling. In this situation, the noise classification system 100 detects the UGC noise, applies the second audio processing settings, and outputs the audio output appropriately.

In general, the noise classification system 100 operates in real time by processing portions of the audio signal 120. Each portion is referred to as a clip, or audio clip, and the noise classification system 100 may perform the process on a clip-by-clip basis. Each audio clip contains a defined number of successive audio frames. Taking the audio with 48 kHz sampling rate as an example, the typical duration for an audio frame can be 1024 samples, about 21.34 milliseconds, and an audio clip can include 48 non-overlapped frames, about 1.024 seconds. Adjacent audio frames may contain overlapped samples. Adjacent audio clips may also contain overlapped frames. For a given input audio clip, the noise detector 102 decides whether it is a noise clip which should be sent to the noise discriminator 104, or whether it belongs to other types, e.g., speech, music, etc., which should not be sent to the noise discriminator 104.

The noise classification system 100 may be referred to as a two-stage noise

classification system. The noise detector 102, also referred to as the first stage, operates to classify a given audio clip according to a defined number of stationary noise-like frames. It should be noted that the stationary noise-like content can be either the captured environmental noise in UGC, also referred to as UGC noise, or noise-like content that is part of the PGC, also referred to as PGC noise. The noise discriminator 104, also referred to as the second stage, is triggered for the approximately stationary noise clip determined by the noise detector 102. The noise discriminator 104 operates to distinguish the noise type in terms of UGC noise versus PGC noise. If the clip is determined to be UGC noise, it will trigger the UGC processing path, via the UGC audio processor 108. Otherwise, it will remain in the original processing path tuned for PGC content processing, via the PGC audio processor 106.

For real content, it is likely that a given audio clip comprises several noise frames and other types of frames, e.g., speech, music, transient sound events, etc. In other words, a pure stationary noise clip is not common. To handle this problem, the noise classification system 100 implements an attention-like mechanism to focus on the noise part of the given audio clip. Specifically, for each frame, the noise detector 102 calculates a frame weight to indicate the likelihood of stationary noise, as further detailed in FIG. 2. The noise detector 102 calculates the frame weight based on a data-driven method, referred to as classification. The noise detector 102 uses the frame weight to calculate a clip confidence, which indicates the likelihood of approximately stationary noise. Additionally, if the audio clip is an approximately stationary noise clip as decided by the noise detector 102, the frame weight will be further used for steering the feature calculation in the noise discriminator 104, as further detailed in FIG. 3.

FIG. 2 is a block diagram showing details of the noise detector 102 (see FIG. 1). In general, the noise detector 102 receives an audio signal, performs noise classification, and generates a confidence score in accordance with the noise classification. The components of the noise detector 102 may be implemented as one or more computer programs that are executed by a processor. The noise detector 102 includes a feature extractor 202, a classifier 204, a model 206, a decider 208, and optionally a root-mean-square (RMS) calculator 210.

The feature extractor 202 receives the audio signal 120, extracts features 220 from the audio signal 120, and provides the features 220 to the classifier 204. As discussed above, the audio signal 120 corresponds to an audio clip of the input audio signal, e.g., 48 frames, which may be non-overlapped, and the feature extractor 202 operates on a portion of the audio clip, e.g., less than 48 frames, referred to as a “short clip”. Using the short clip, instead of using just the current frame, may provide an increased generalization ability when calculating the noise confidence score. Here, “generalization” refers to the ability of the noise detector 102 to adapt to new, previously unseen data. The short clip may include the current frame of the clip and a number of history frames. For example, the short clip may include five successive frames, e.g., the current frame and the four previous frames. The current short clip may be overlapped with the previous short clip. For example, the overlap may have a hop size of one frame. In other words, the short clip moves one frame for each step. As an example, for a given clip with 48 frames, one short clip is frames 1-5, another short clip is frames 2-6, another short clip is frames 3-7, etc., with another short clip being frames 44-48. Each frame is represented by its context, e.g., the frame itself and the four previous frames, generally corresponding to the short clip, the features are extracted from this context, and the classification is also performed based on this context. In this manner, the noise detector 102 operates on a short clip-by-short clip basis.

The features 220 correspond to the audio features of the short clip. These audio features include one or more of temporal features, spectral features, temporal-frequency features, etc. The temporal features may include one or more of autocorrection coefficients (ACC), linear prediction coding coefficients (LPCC), zero-crossing rate (ZCR), etc. The spectral features may include one or more of spectral centroid, spectral roll-off, spectral energy distribution, spectral flatness, spectral entropy, Mel-frequency cepstrum coefficients (MFCC), etc. The temporal-frequency features may include one or more of spectral flux, chroma, etc. The features 220 may also include statistics of the other features described above. These statistics may include mean, standard deviation, and higher-order statistics, e.g., skewness, kurtosis, etc. For example, the features 220 may include the mean and standard deviation of the spectral energy distribution.

The classifier 204 receives the features 220, performs classification of the features 220 using the model 206, and generates a noise confidence score 222. For each frame in a given clip, the classifier 204 may calculate the noise confidence score 222 for each frame based on the context of the frame, e.g., the current frame and the four previous frames, corresponding to a short clip. The noise confidence score 222 may range from zero to one, where a higher score means higher likelihood of a noise frame and vice versa.

The classifier 204 may correspond to a machine learning system, and the model 206 may correspond to a machine learning model. The model 206 may have been obtained by data-driven methods, and the model 206 may have been trained offline using a set of training data that includes positive training data, e.g., “noise” data including both UGC noise and

PGC noise, and negative training data, e.g., “non-noise” data such as music, speech, etc. In other words, the training data has been tagged into the various categories, e.g. UGC noise, PGC noise, non-noise, and the model 206 results from the model 206 having been exposed to the training data during the training process. As a result, one definition for “PGC” is “data that has been tagged in the training process as being professionally-generated content”, one definition for “PGC noise” is “data that has been tagged in the training process as being professionally-generated content and having noise”, one definition for “UGC” is “data that has been tagged in the training process as being other than professionally-generated content”, and one definition for “UGC noise” is “data that has been tagged in the training process as being other than professionally-generated content and having noise”. An amount of training data that provides acceptable results is 50 hours of training data. This amount may be varied as desired, with a reduced amount potentially resulting in a less accurate model and an increased amount potentially resulting in a more accurate model. In general, the features 220 extracted by the feature extractor 202 correspond to the features used when training the model 206, e.g., the features extracted from each short clip.

The classifier 204 may implement a variety of machine learning systems, including an adaptive boosting (AdaBoost) system, a deep neural network (DNN) system, etc. In general, the AdaBoost system combines the output of other learning algorithms, also referred to as “weak learners”, into a weighted sum, and is “adaptive” in the sense that subsequent weak learners are tweaked in favor of those instances misclassified by previous classifiers. In general, the DNN system is a neural network having multiple layers between the input layer and the output layer. For the AdaBoost classifier, the classifier 204 may convert the output noise confidence to the interval [0,1] by applying a sigmoid function. The sigmoid function σ(z) may be defined according to Equation (1):

$$σ ( z ) = \frac{1}{1 + {e}^{- z}} \qquad ( 1 )$$

In Equation (1), the output noise confidence σ(z) is converted to the interval [0,1] due to the operation of the inverse exponential function to the input z, which is the combination of the outputs of the weak learners. The output noise confidence approaches 0 as the input decreases, is 0.5 when the input is 0, and approaches 1 as the input increases; consequently the output noise confidence increases as the input z increases.

If the DNN is used, the classifier 204 may use the sigmoid function as the activation function of the output layer. In any event, the classifier 204 sends the obtained noise confidence scores to the decider 208 as the noise confidence score 222.

The decider 208 receives the noise confidence score 222 and generates a weight 224 based on the noise confidence score 222. The decider 208 also calculates a clip confidence w_{c} based on the noise confidence score 222. When the clip confidence is greater than a defined threshold value, the clip is classified as noise and sent to the noise discriminator 104. In other words, the noise confidence score 222 for each frame in a given clip is used to calculate the clip confidence w_{c} that is used to classify the given clip. Further details regarding the clip confidence we are provided below with reference to Equation (4) and Equation (8).

The decider 208 uses the noise confidence score 222 to calculate the weight 224, also referred to as the frame weight, as per Equation (2):

$${w}_{f} ( i ) = {σ}^{′} ( n ( i ) ) \qquad ( 2 )$$

In Equation (2), i is the current frame number, w_{f}(i) is the weight 224 of the current frame, n(i) is the noise confidence score 222 of the current frame, and σ′ (·) is a modified sigmoid function defined according to Equation (3):

$${σ}^{′} ( n ( i ) ) = \frac{1}{1 + exp ( - C ( n ( i ) - θ ) )} \qquad ( 3 )$$

In Equation (3), C is a scale factor and 0 is a threshold value. Generally, C is a positive value. A typical value for C is 16, e.g., in the range 10-20, and a typical value for θ is 0.5, e.g., in the range 0.45-0.55. Accordingly, the weight 224 increases as the noise confidence score 222 exceeds the threshold, and the weight 224 decreases as the noise confidence score 222 falls below the threshold. The scale factor C may be adjusted to adjust the balance between the weight 224 and the noise confidence score 222; decreasing the scale factor decreases the contribution of the weight 224, and increasing the scale factor increases the contribution of the weight 224. The threshold value 0 may be adjusted to adjust the sensitivity of the noise detection; increasing the threshold value decreases the weight 224, and decreasing the threshold value increases the weight 224.

The decider 208 uses the weight 224 not only for calculating the clip confidence, as discussed in more detail below, but also for determining whether or not the clip is sent to the noise discriminator 104, as discussed in more detail with reference to FIG. 3. The clip confidence calculation uses the number of noise frames in the clip. To measure the number of noise frames in the clip, the decider 208 calculates a noiseness weight wₙₒᵢ using Equation (4):

$${w}_{noi} = \frac{{\sum }_{i} c ( i ) {w}_{f} ( i )}{{\sum }_{i} c ( i )} \qquad ( 4 )$$

In Equation (4), c(i) is the constant coefficient applied for the i-th frame. It should be noted that the coefficient c(i) can be either the same for all frames or can vary for different frames. If the coefficients are same, the weight wₙₒᵢ approximates the percentage of noise-like frames among the whole clip. Alternatively, in other scenarios where low latency is desired, the coefficients can be increasing over time. That means, the current frame will be assigned to the largest coefficient while the previous frames are assigned to the smaller coefficient. This manner helps the framework to quickly respond to the current frame.

In other words, the noiseness weight wₙₒᵢ is the ratio between two components: (1) the frame weight and the constant coefficient for each frame summed over all the frames in the clip, and (2) the constant coefficient for each frame summed over all the frames in the clip. In effect, the noiseness weight is a weighted combination of the frame weights.

The clip confidence w_{c} then corresponds to the noiseness weight wₙₒᵢ. Note that

the clip confidence ranges from 0 to 1, inclusive.

When the clip confidence w_{c} exceeds a defined threshold, the clip and the weight 224 are sent to the noise discriminator 104 for further processing. A typical value for the threshold is 0.5. When the clip confidence w_{c} does not exceed the defined threshold, the clip is processed by the PGC audio processor 106.

The RMS calculator 210 is optional. When present, the RMS calculator 210 operates to restrict the audio RMS to a specific range. The motivation is that the noise within a specific RMS/loudness range would aggravate the artifacts caused by the post-processing techniques, e.g., loudness adjustment methods, while in other ranges the artifacts would not be perceptually notable. A straight-forward approach would be using hard decisions with predefined thresholds. That is, any noise clips whose RMS beyond the thresholds would not be processed. However, this could cause instability, especially for those clips whose RMS frequently fluctuate around the thresholds.

To overcome the instability issue, the RMS calculator 210 calculates an average RMS gain 226 for each frame. Since the RMS gains will be used to weight the noise confidence scores, see the modified calculation of the clip confidence w_{c} discussed below, it would be beneficial to operate on the short clip level to keep consistent with the feature extraction performed by the feature extractor 202. Specifically, if the RMS of the i-th frame is denoted by p (n), the short clip level RMS for the i-th frame is calculated by Equation (5):

$$\overline{p} ( i ) = \frac{1}{L} {\sum }_{n = i - L + 1}^{i} p ( n ) \qquad ( 5 )$$

In Equation (5), L is the short clip length in frames, e.g. 5 frames.

When the RMS calculator 210 is present, the decider 208 also receives the average RMS gain 226. The decider 208 calculates an RMS-based weight wᵣₘₛ using Equation (6):

$${w}_{rms} = g ( \frac{{\sum }_{i} \overline{p} ( i ) {w}_{f} ( i )}{{\sum }_{i} {w}_{f} ( i )} ) \qquad ( 6 )$$

In Equation (6), p̅(i) is the short clip RMS gain for the i-th frame, and g is a function that defines a mapping into the interval [0,1] as per Equation (7):

$$g ( z ) = \{ \begin{matrix}max ( 0 , {a}_{L} ( z - {P}_{L} ) + 1 ) , z \leq {P}_{L} \\ 1 , {P}_{L} < z \leq {P}_{U} \\ max ( 0 , {a}_{U} ( z - {P}_{U} ) + 1 ) , z > {P}_{U}\end{matrix} \qquad ( 7 )$$

In Equation (7), P_{L} is the lower bound of the RMS interval, P_{U} is the upper bound of the RMS interval, a_{L} is a number greater than zero, and a_{U} is a number less than zero.

In other words, Equation (6) describes that the RMS-based weight wᵣₘₛ

corresponds to the function g applied to the ratio between two components: (1) the frame weight and the average RMS gain for each frame summed over all the frames in the clip, and (2) the weight for each frame summed over all the frames in the clip. Equation (7) describes that the function g is applied such that when the ratio of Equation (6) is less than or equal to the lower bound of the RMS interval, the lower bound of the RMS interval is applied to the ratio to generate the RMS-based weight; when the ratio of Equation (6) is greater than the upper bound of the RMS interval, the upper bound of the RMS interval is applied to the ratio to generate the RMS-based weight; otherwise the RMS-based weight is set to 1.

The decider 208 calculates the clip confidence w_{c} according to Equation (8):

$${w}_{c} = {w}_{noi} {w}_{rms} \qquad ( 8 )$$

In Equation (8), wₙₒᵢ is the noiseness weight as per Equation (4), and wᵣₘₛ is the RMS-based weight as per Equation (6). In other words, the clip confidence is a combination of the noiseness weight and the RMS-based weight.

FIG. 3 is a block diagram showing details of the noise discriminator 104 (see FIG. 1). In general, the noise discriminator 104 receives an audio signal, e.g. that has been classified as noise by the noise detector 102, performs noise discrimination, and generates a confidence score in accordance with the noise discrimination. The components of the noise discriminator 104 may be implemented as one or more computer programs that are executed by a processor. The noise discriminator 104 includes a feature extractor 302, a classifier 304, a model 306, and a decider 308.

The feature extractor 302 receives the audio signal 120 and the weight 224 (see FIG. 2), extracts features 320 from the audio signal 120 based on the weight 224. As discussed above, the audio signal 120 corresponds to an audio clip of the input audio signal, e.g., 48 frames, which may be non-overlapped, and the feature extractor 302 operates on the audio clip. Recall that the noise detector 102 operates on the short clip, so the noise discriminator 104 operates on a longer time period than the noise detector 102. More specifically, for a given clip, the feature extractor 302 extracts various features for each frame in the clip, also referred to as frame features, and the feature extractor 302 calculates statistics of the frame features. The features extractor 302 uses the weight 224 as weighting coefficients when calculating the statistics. The features 320 then correspond to both the frame features, which are extracted based on each frame, and the statistics, which are calculated based on the clip.

In this manner, the noise discriminator 104 operates on a clip-by-clip basis.

The frame features extracted by the feature extractor 302 may include one or more of temporal features, spectral features, temporal-frequency features, etc. The temporal features may include one or more of autocorrection coefficients (ACC), linear prediction coding coefficients (LPCC), zero-crossing rate (ZCR), etc. The spectral features may include one or more of spectral centroid, spectral roll-off, spectral energy distribution, spectral flatness, spectral entropy, Mel-frequency cepstrum coefficients (MFCC), etc. The temporal-frequency features may include one or more of spectral flux, chroma, etc. The frame features extracted by the feature extractor 302 may be the same type of features as the features 220 extracted by the feature extractor 202 (see FIG. 2).

The feature extractor 302 may calculate various weighted statistics, including a weighted mean, a weighted standard deviation, etc. The feature extractor 302 may calculate the weighted mean u using Equation (9):

$$μ = \frac{{\sum }_{i - M + 1}^{i} {w}_{f} ( i ) v ( i )}{{\sum }_{i} {w}_{f} ( i )} \qquad ( 9 )$$

In Equation (9), v(i) corresponds to the frame feature v extracted in frame i, also referred to as the frame index i, w_{f} corresponds to the frame weight, see Equation (2) and the weight 224, and M corresponds to the total number of frames in the clip, e.g., 48 frames. In other words, the weighted mean corresponds to a ratio between (1) the sum of the weighted frame features and (2) the sum of the weight, for a given clip.

The feature extractor 302 may calculate the weighted standard deviation o using Equation (10):

$$σ = {( \frac{{\sum }_{i - M + 1}^{i} {w}_{f} ( i ) {( v ( i ) - μ )}^{2}}{{\sum }_{i} {w}_{f} ( i )} )}^{1 / 2} \qquad ( 10 )$$

The variables in Equation (10) are as described above regarding Equation (9). In other words, the weighted standard deviation corresponds to the square root of the ratio between (1) the weighted sum of the square of the frame features and (2) the sum of the weight, for a given clip.

The classifier 304 receives the features 320, performs classification of the features 320 using the model 306, and generates a noise confidence score 322. The noise confidence score 322 indicates the likelihood of PGC noise versus the likelihood of UGC noise. For example, the classifier 304 may implement a sigmoid function to convert the noise confidence score 322 to the interval [0,1], with a score near 0 indicating a high likelihood of one type, e.g., UGC noise, and a score near 1 indicating a high likelihood of the other type, e.g., PGC noise.

The classifier 304 may correspond to a machine learning system, and the model 306 may correspond to a machine learning model. The model 306 may have been obtained by data-driven methods, and may have been trained offline using a set of training data that includes PGC noise training data and UGC noise training data. In other words, the training data has been tagged into the various categories, e.g. UGC noise, PGC noise, etc., and the model 306 results from the model 306 having been exposed to the training data during the training process. Viewing the PGC noise training data as “positive” training data and the UGC noise training data as “negative” training data, the noise confidence score 322 is greater, e.g., greater than 0.5, when the features 320 correspond to PGC, and is lesser, e.g., lesser than 0.5, when the features 320 correspond to UGC. An amount of training data that provides acceptable results is 50 hours of training data. This amount may be varied as desired, with a reduced amount potentially resulting in a less accurate model and an increased amount potentially resulting in a more accurate model. In general, the features 320 extracted by the feature extractor 302 correspond to the features used when training the model 306, e.g., the features extracted from each frame in a given clip, and the statistics computed therefrom.

The classifier 304 may implement a variety of machine learning systems, including an adaptive boosting (AdaBoost) system, a deep neural network (DNN) system, etc. For the AdaBoost classifier, the classifier 304 may convert the noise confidence score to the interval [0,1] by applying a sigmoid function (see Equation (1)). If the DNN is used, the classifier 304 may use the sigmoid function as the activation function of the output layer.

The decider 308 receives the noise confidence score 322 and generates a classification result 324 based on the noise confidence score 322 and a threshold. When the noise confidence score 322 is greater than the threshold, the clip is classified as PGC, e.g. when the “positive” training data corresponds to PGC training data, and the noise discriminator 104 controls the PGC audio processor 106 to process the clip according to the desired PGC audio processing techniques such as volume leveling, etc. When the noise confidence score 322 is less than the threshold, the clip is classified as UGC, e.g. when the “negative” training data corresponds to UGC training data, and the noise discriminator 104 controls the UGC audio processor 108 to process the clip according to the desired UGC audio processing techniques such as stationary noise reduction, etc.

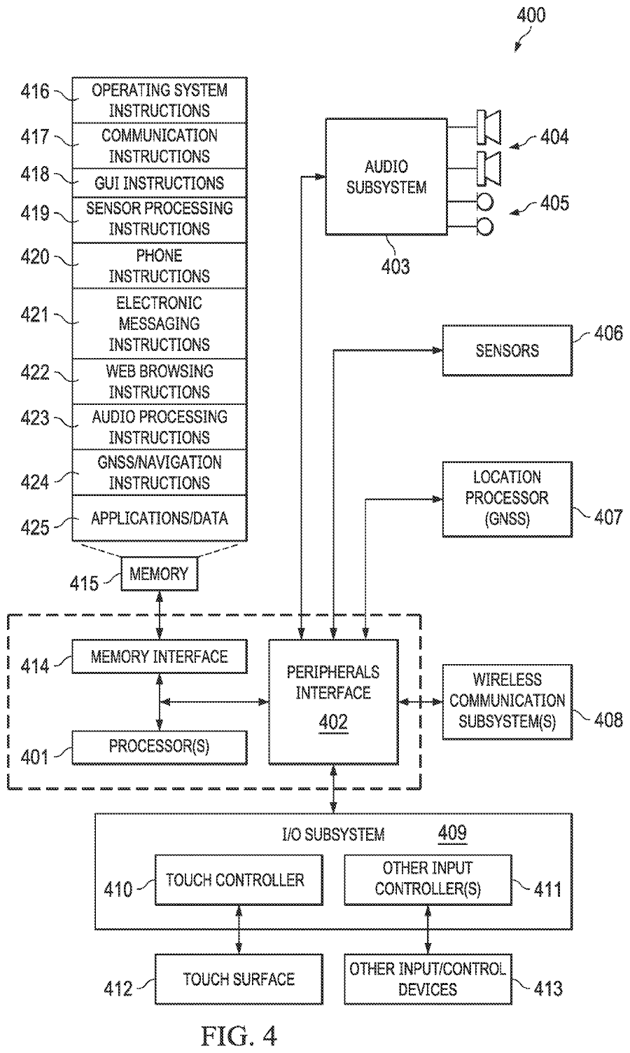

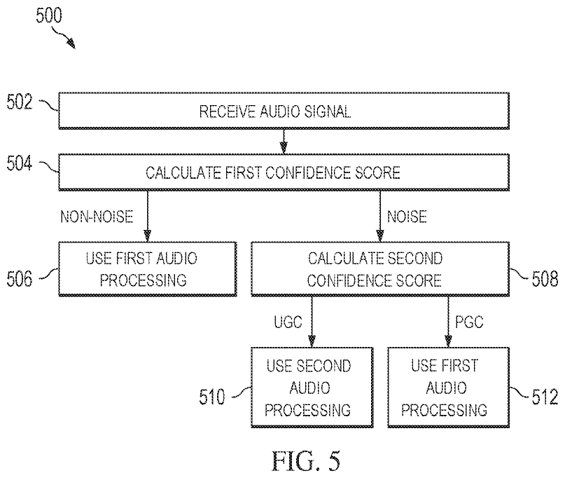

FIG. 4 is a mobile device architecture 400 for implementing the features and processes described herein, according to an embodiment. The architecture 400 may be implemented in any electronic device, including but not limited to: a desktop computer, consumer audio/visual (AV) equipment, radio broadcast equipment, mobile devices such as smartphone, tablet computer, laptop computer, wearable device, etc. In the example embodiment shown, the architecture 400 is for a laptop computer and includes processor(s) 401, peripherals interface 402, audio subsystem 403, loudspeakers 404, microphone 405, sensors 406 such as accelerometers, gyros, barometer, magnetometer, camera, location processor 407 such as GNSS receiver, wireless communications subsystems 408 such as Wi-Fi, Bluetooth, cellular, and I/O subsystem(s) 409, which includes touch controller 410 and other input controllers 411, touch surface 412 and other input/control devices 413. Other architectures with more or fewer components can also be used to implement the disclosed embodiments.

Memory interface 414 is coupled to processors 401, peripherals interface 402 and memory 415 such as flash, RAM, ROM. Memory 415 stores computer program instructions and data, including but not limited to: operating system instructions 416, communication instructions 417, GUI instructions 418, sensor processing instructions 419, phone instructions 420, electronic messaging instructions 421, web browsing instructions 422, audio processing instructions 423, GNSS/navigation instructions 424 and applications/data 425. Audio processing instructions 423 include instructions for performing the audio processing described herein.

According to an embodiment, the architecture 400 may correspond to a mobile telephone. The user may use the mobile telephone to output PGC, in which case the noise classification system 100 (see FIG. 1) controls the mobile telephone to generate the audio output using the audio processing appropriate for PGC, e.g. the PGC audio processor 106.

The user may use the mobile telephone to capture and to output UGC, in which case the noise classification system controls the mobile telephone to generate the audio output using the audio processing appropriate for UGC, e.g. the UGC audio processor 108.

FIG. 5 is a flowchart of a method 500 of audio processing. The method 500 may be performed by a device such as a laptop computer, a mobile telephone, etc. with the components of the architecture 400 of FIG. 4, to implement the functionality of the noise classification system 100 (see FIG. 1), etc., for example by executing one or more computer programs.

At 502, an audio signal is received. For example, the noise classification system 100 (see FIG. 1) may receive the audio signal 120. The audio signal 120 may include audio samples, the audio samples may be arranged as audio frames, the audio frames may be arranged into audio clips, and the audio signal 120 may be processed in real time on a clip-by-clip basis.

At 504, a first confidence score of the audio signal is calculated using a first machine learning model. For example, the noise detector 102 (see FIG. 2) may calculate the clip confidence of a given clip using the model 206. The noise detector 102 may include a feature extractor 202 that operates on a portion of the clip, referred to as a short clip.

At 506, when the first confidence score indicates the presence of non-noise, a processed audio signal is generated by processing the audio signal according to a first audio processing process. For example, when the noise detector 102 (see FIG. 1) indicates the absence of noise, the PGC audio processor 106 may perform PGC audio processing on the clip to generate the processed audio signal.

At 508, when the first confidence score indicates the presence of noise, a second confidence score of the audio signal is calculated using a second machine learning model.

For example, the noise discriminator 104 (see FIG. 3) may calculate the noise confidence score 322 using the model 306 applied to the features 320. The second confidence score may be calculated based on the clip, e.g. by extracting the features from each frame in the clip. Recall that the first confidence score is calculated based on the short clip, see 504.

At 510, when the second confidence score indicates the presence of UGC noise, the processed audio signal is generated by processing the audio signal according to a second audio processing process. For example, when the noise discriminator 104 (see FIG. 1) indicates the presence of UGC noise, the UGC audio processor 108 may perform UGC audio processing on the clip to generate the processed audio signal.

At 512, when the second confidence score indicates the presence PGC noise, the processed audio signal is generated by processing the audio signal according to the first audio processing process. For example, when the noise discriminator 104 (see FIG. 1) indicates the presence of PGC noise, the PGC audio processor 106 may perform PGC audio processing on the clip to generate the processed audio signal.

The processed audio signal may then be stored in the memory of the device, e.g. in a solid-state memory, transmitted to another device, e.g. for cloud storage, outputted as sound, e.g. using a loudspeaker, etc.

The method 500 may include additional steps corresponding to the other functionalities of the noise classification system 100, etc. as described herein. For example, calculating the first confidence score may include calculating a weight, where the weight is used in calculating the second confidence score. As another example, calculating the first confidence score may include calculating an average RMS of the audio signal, and using the calculated average RMS when calculating the first confidence score. As another example, calculating the second confidence score may include using the weight when calculating a second plurality of statistics.

### Implementation Details

An embodiment may be implemented in hardware, executable modules stored on a computer readable medium, or a combination of both, e.g. programmable logic arrays. Unless otherwise specified, the steps executed by embodiments need not inherently be related to any particular computer or other apparatus, although they may be in certain embodiments.

In particular, various general-purpose machines may be used with programs written in accordance with the teachings herein, or it may be more convenient to construct more specialized apparatus, e.g. integrated circuits, to perform the required method steps. Thus, embodiments may be implemented in one or more computer programs executing on one or more programmable computer systems each comprising at least one processor, at least one data storage system, including volatile and non-volatile memory and/or storage elements, at least one input device or port, and at least one output device or port. Program code is applied to input data to perform the functions described herein and generate output information. The output information is applied to one or more output devices, in known fashion.

Each such computer program is preferably stored on or downloaded to a storage media or device, e.g., solid state memory or media, or magnetic or optical media, readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. Software per se and intangible or transitory signals are excluded to the extent that they are unpatentable subject matter.

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components

may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical, non-transitory, non-volatile storage media in various forms, such as optical, magnetic or semiconductor storage media.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

Various aspects of the present invention may be appreciated from the following enumerated example embodiments (EEEs):
EEE1. A computer-implemented method of audio processing, the method comprising:
receiving an audio signal;
calculating a first confidence score of the audio signal using a first machine learning model;
when the first confidence score indicates a presence of non-noise:
   generating a processed audio signal by processing the audio signal according to a first audio processing process;
when the first confidence score indicates a presence of noise:
   calculating a second confidence score of the audio signal using a second machine learning model;
when the second confidence score indicates a presence of noise of a first type:
   generating the processed audio signal by processing the audio signal according to a second audio processing process; and
when the second confidence score indicates a presence of noise of a second type:
   generating the processed audio signal by processing the audio signal according to the first audio processing process.
EEE2. The computer-implemented method of EEE 1, further comprising:
outputting, by a loudspeaker, the processed audio signal as sound.
EEE3. The computer-implemented method of any one of EEEs 1-2, wherein the audio signal comprises a plurality of samples, wherein the plurality of samples is arranged into a plurality of frames;
wherein the first confidence score is calculated in real time on a short clip-by-short clip basis;
wherein the second confidence score is calculated in real time on a clip-by-clip basis; and
wherein a given short clip and a given clip each include a number of frames of the audio signal, wherein the given short clip includes fewer frames than the given clip.
EEE4. The computer-implemented method of any one of EEEs 1-3, wherein the first audio processing process comprises audio processing other than noise reduction; and
wherein the second audio processing process comprises noise reduction.
EEE5. The computer-implemented method of any one of EEEs 1-4, wherein the noise of the first type corresponds to user-generated content (UGC) noise, wherein the noise of the second type corresponds to professionally-generated content (PGC) noise, wherein PGC is audio content that has been created professionally, and wherein UGC is audio content that has been created other than professionally.
EEE6. The computer-implemented method of any one of EEEs 1-5,
wherein the first machine learning model has been trained offline using positive training data and negative training data,
wherein the positive training data includes training data corresponding to the noise of the first type and training data corresponding to the noise of the second type, and
wherein the negative training data includes non-noise training data.

EEE7. The computer-implemented method of any one of EEEs 1-6, wherein calculating the first confidence score comprises:
extracting a first plurality of features from the audio signal;
classifying the audio signal by inputting the first plurality of features into the first machine learning model; and
calculating a noise confidence score based on a result of classifying the audio signal.
EEE8. The computer-implemented method of EEE 7, wherein a first plurality of features is extracted from a short clip that includes a current frame and a plurality of history frames, wherein the noise confidence score of the current frame results from inputting the first plurality of features of the short clip into the first machine learning model.
EEE9. The computer-implemented method of any one of EEEs 7-8, the method further comprising:
calculating noise confidence scores for a plurality of frames in a clip; and
calculating a noise confidence score for the clip as a weighted combination of the noise confidence scores for the plurality of frames.
EEE10. The computer-implemented method of any one of EEEs 7-9, wherein calculating the noise confidence score comprises:
combining a plurality of outputs of a plurality of weak learners into a weighted sum; and
converting the weighted sum into the noise confidence score using an inverse exponential function.
EEE11. The computer-implemented method of any one of EEEs 7-10, wherein calculating the first confidence score further comprises:
calculating an average root mean square gain of the audio signal,
wherein calculating the noise confidence score comprises calculating the noise confidence score based on the result of classifying the audio signal and the average root mean square gain of the audio signal.
EEE12. The computer-implemented method of EEE 11, wherein the noise confidence score and the average root mean square gain are associated with a current frame of the audio signal, wherein calculating the average root mean square gain comprises:
calculating the average root mean square gain as an average of a root mean square level of a plurality of frames of a short clip that includes the current frame; and
calculating a root mean square-based weight based on a ratio of a first factor and a second factor, wherein the first factor is the product of the average root mean square gain and a frame weight of the current frame, and wherein the second factor is the frame weight of the current frame,
the method further comprising:
calculating a plurality of noise confidence scores for a plurality of frames in a clip;
calculating a noiseness weight for the clip as a weighted combination of the plurality of noise confidence scores; and
calculating a clip confidence score by multiplying the root mean square-based weight and the noiseness weight.
EEE13. The computer-implemented method of any one of EEEs 7-12, wherein the first plurality of features includes one or more of a plurality of temporal features, a plurality of spectral features, a plurality of temporal-frequency features, and a first plurality of statistics, and/or
wherein the first plurality of statistics comprises one or more of a mean and a standard deviation, where the mean is calculated based on one or more of the first plurality of features and the standard deviation is calculated based on one or more of the first plurality of features.
EEE14. The computer-implemented method of any one of EEEs 7-13, further comprising calculating a weight based on the noise confidence score, wherein calculating the second confidence score comprises:
extracting a second plurality of features from the audio signal, wherein the second plurality of features is extracted over a longer time period than the first plurality of features is extracted;
calculating a second plurality of statistics based on the second plurality of features, wherein the second plurality of statistics is weighted according to the weight;
classifying the audio signal by inputting the second plurality of features and the second plurality of statistics into the second machine learning model; and
calculating the second confidence score based on a result of classifying the audio signal.
EEE15. The computer-implemented method of EEE 14, wherein the first plurality of features is extracted from a first plurality of frames of a short clip of the audio signal, and wherein the second plurality of features is extracted from second plurality of frames of a clip of the audio signal.
EEE16. The computer-implemented method of any one of EEEs 14-15, wherein the weight is a frame weight of the current frame, wherein calculating the frame weight comprises:
calculating the frame weight by applying a modified sigmoid function to the noise confidence score of the current frame, wherein the frame weight increases as the noise confidence score exceeds a threshold, and wherein the frame weight decreases as the noise confidence score falls below the threshold.
EEE17. The computer-implemented method of any one of EEEs 14-16, wherein the audio signal comprises a clip, wherein the clip comprises a plurality of frames, wherein the second plurality of features comprises a plurality of frame features and a plurality of statistics, wherein the plurality of frame features is extracted on a per-frame basis, and wherein the plurality of statistics is calculated based on the plurality of frame features on a per-clip basis.
EEE18. The computer-implemented method of any one of EEEs 1-17, wherein the second machine learning model has been trained offline using positive training data and negative training data,
wherein the positive training data includes training data corresponding to the noise of the second type, and
wherein the negative training data includes training data corresponding to the noise of the first type.
EEE19. A non-transitory computer readable medium storing a computer program that, when executed by a processor, controls an apparatus to execute processing including the method of any one of EEEs 1-18.
EEE20. An apparatus for audio processing, the apparatus comprising: a processor, wherein the processor is configured to control the apparatus to execute processing including the method of any one of EEEs 1-18.

### REFERENCES

U.S. Pat. Nos. 9,064,497; 9,107,010; 9,984,701; 8,682,250; 8,238,497; 6,859,773; 7,171,246; 7,684,982; 9,633,671; 9,769,564; 7,464,029; 9,711,130; 8,325,939; 9,609,416; 9,934,791.

U.S. Patent Application Pub. Nos. 2016/0155434; 2020/0125316; 2020/0020312.

Fatemeh Saki, Abhishek Sehgal, Issa Panahi and Nasser Kehtarnavaz, “Smartphone-Based Real-Time Classification of Noise Signals using Subband Features and Random Forest Classifier”, in 2016 IEEE International Conference on Acoustics, Speech and Signal Processing (ICASSP), DOI 10.1109/ICASSP.2016.7472068.

Vanishree Gopalakrishna, Nasser Kehtarnavaz, Taher S. Mirzahasanloo and Philipos C. Loizou, “Real-Time Automatic Tuning of Noise Suppression Algorithms for Cochlear Implant Applications”, in IEEE Transactions on Biomedical Engineering (Volume: 59, Issue: 6, June 2012), DOI 10.1109/TBME.2012.2191968.

Fatemeh Saki and Nasser Kehtarnavaz, “Background noise classification using random forest tree classifier for cochlear implant applications”, in 2014 IEEE International Conference on Acoustics, Speech and Signal Processing (ICASSP), DOI 10.1109/ICASSP.2014.6854270.

Fatemeh Saki, Taher Mirzahasanloo and Nasser Kehtarnavaz, “A multi-band environment-adaptive approach to noise suppression for cochlear implants”, in Annu Int Conf IEEE Eng Med Biol Soc 2014, DOI 10.1109/EMBC.2014.6943934.

Peipei Shen, Zhou Changjun and Xiong Chen, “Automatic Speech Emotion Recognition using Support Vector Machine”, in Proceedings of 2011 International Conference on Electronic & Mechanical Engineering and Information Technology, DOI 10.1109/EMEIT.2011.6023178.

Humaid Alshamsi, Veton Kepuska, Hazza Alshamsi and Hongying Meng, “Automated Speech Emotion Recognition on Smart Phones”, in 2018 9th IEEE Annual Ubiquitous Computing, Electronics & Mobile Communication Conference (UEMCON), DOI 10.1109/UEMCON.2018.8796594.

1. A computer-implemented method of audio processing, the method comprising:
receiving an audio signal;
calculating a first confidence score of the audio signal using a first machine learning model trained to classify an audio signal as non-noise or noise;
when the first confidence score indicates a presence of non-noise:
generating a processed audio signal by processing the audio signal according to a first audio processing process;
when the first confidence score indicates a presence of noise:
calculating a second confidence score of the audio signal using a second machine learning model trained to distinguish between noise of a first type and noise of a second type;
when the second confidence score indicates a presence of noise of the first type:
generating the processed audio signal by processing the audio signal according to a second audio processing process; and
when the second confidence score indicates a presence of noise of the second type:
generating the processed audio signal by processing the audio signal according to the first audio processing process.

2. The computer-implemented method of claim 1, further comprising: outputting, by a loudspeaker, the processed audio signal as sound.

3. The computer-implemented method of claim 1, wherein the audio signal comprises a plurality of samples, wherein the plurality of samples is arranged into a plurality of frames;
wherein the first confidence score is calculated in real time on a short clip-by-short clip basis;
wherein the second confidence score is calculated in real time on a clip-by-clip basis; and
wherein a given short clip and a given clip each include a number of frames of the audio signal, wherein the given short clip includes fewer frames than the given clip.

4. The computer-implemented method of claim 1, wherein the first audio processing process comprises audio processing other than noise reduction; and
wherein the second audio processing process comprises noise reduction.

5. The computer-implemented method of claim 1, wherein the noise of the first type corresponds to user-generated content (UGC) noise, wherein the noise of the second type corresponds to professionally-generated content (PGC) noise, wherein PGC is audio content that has been created professionally, and wherein UGC is audio content that has been created other than professionally.

6. The computer-implemented method of claim 1,
wherein the first machine learning model has been trained offline using positive training data and negative training data,
wherein the positive training data includes training data corresponding to the noise of the first type and training data corresponding to the noise of the second type, and
wherein the negative training data includes non-noise training data.

7. The computer-implemented method of claim 1, wherein calculating the first confidence score comprises:
extracting a first plurality of features from the audio signal;
classifying the audio signal by inputting the first plurality of features into the first machine learning model; and
calculating a noise confidence score based on a result of classifying the audio signal.

8. The computer-implemented method of claim 7, wherein a first plurality of features is extracted from a short clip that includes a current frame and a plurality of history frames, wherein the noise confidence score of the current frame results from inputting the first plurality of features of the short clip into the first machine learning model.

9. The computer-implemented method of claim 7, the method further comprising:
calculating noise confidence scores for a plurality of frames in a clip; and
calculating a noise confidence score for the clip as a weighted combination of the noise confidence scores for the plurality of frames.

10. The computer-implemented method of claim 7, wherein calculating the noise confidence score comprises:
combining a plurality of outputs of a plurality of weak learners into a weighted sum; and
converting the weighted sum into the noise confidence score using an inverse exponential function.

11. The computer-implemented method of claim 7, wherein calculating the first confidence score further comprises:
calculating an average root mean square gain of the audio signal,
wherein calculating the noise confidence score comprises calculating the noise confidence score based on the result of classifying the audio signal and the average root mean square gain of the audio signal.

12. The computer-implemented method of claim 11, wherein the noise confidence score and the average root mean square gain are associated with a current frame of the audio signal, wherein calculating the average root mean square gain comprises:
calculating the average root mean square gain as an average of a root mean square level of a plurality of frames of a short clip that includes the current frame; and
calculating a root mean square-based weight based on a ratio of a first factor and a second factor, wherein the first factor is the product of the average root mean square gain and a frame weight of the current frame, and wherein the second factor is the frame weight of the current frame,
the method further comprising:
calculating a plurality of noise confidence scores for a plurality of frames in a clip;
calculating a noiseness weight for the clip as a weighted combination of the plurality of noise confidence scores; and
calculating a clip confidence score by multiplying the root mean square-based weight and the noiseness weight.

13. The computer-implemented method of claim 7, wherein the first plurality of features includes one or more of a plurality of temporal features, a plurality of spectral features, a plurality of temporal-frequency features, and a first plurality of statistics, and/or
wherein the first plurality of statistics comprises one or more of a mean and a standard deviation, where the mean is calculated based on one or more of the first plurality of features and the standard deviation is calculated based on one or more of the first plurality of features.

14. The computer-implemented method of claim 7, further comprising calculating a weight based on the noise confidence score, wherein calculating the second confidence score comprises:
extracting a second plurality of features from the audio signal, wherein the second plurality of features is extracted over a longer time period than the first plurality of features is extracted;
calculating a second plurality of statistics based on the second plurality of features, wherein the second plurality of statistics is weighted according to the weight;
classifying the audio signal by inputting the second plurality of features and the second plurality of statistics into the second machine learning model; and
calculating the second confidence score based on a result of classifying the audio signal.

15. The computer-implemented method of claim 14, wherein the first plurality of features is extracted from a first plurality of frames of a short clip of the audio signal, and wherein the second plurality of features is extracted from second plurality of frames of a clip of the audio signal.

16. The computer-implemented method of claim 14, wherein the weight is a frame weight of the current frame, wherein calculating the frame weight comprises:
calculating the frame weight by applying a modified sigmoid function to the noise confidence score of the current frame, wherein the frame weight increases as the noise confidence score exceeds a threshold, and wherein the frame weight decreases as the noise confidence score falls below the threshold.

17. The computer-implemented method of claim 14, wherein the audio signal comprises a clip, wherein the clip comprises a plurality of frames, wherein the second plurality of features comprises a plurality of frame features and a plurality of statistics, wherein the plurality of frame features is extracted on a per-frame basis, and wherein the plurality of statistics is calculated based on the plurality of frame features on a per-clip basis.

18. The computer-implemented method of claim 1, wherein the second machine learning model has been trained offline using positive training data and negative training data,
wherein the positive training data includes training data corresponding to the noise of the second type, and
wherein the negative training data includes training data corresponding to the noise of the first type.

19. A non-transitory computer readable medium storing a computer program that, when executed by a processor, controls an apparatus to execute processing including the method of claim 1.

20. An apparatus for audio processing, the apparatus comprising:
a processor, wherein the processor is configured to control the apparatus to execute processing including the method of claim 1.
